(19) United States
(12) Patent Application Publication
(10) Pub. No.: US 2011/0107919 A1
(43) Pub. Date: May 12, 2011

(54) Multiple brewing and dispensing decanter

(76) Inventor: Joseph P. Webster, St. Charles, MO (US)

(21) Appl. No.: 12/927,014

(22) Filed: Nov. 4, 2010

Related U.S. Application Data
(60) Provisional application No. 61/280,658, filed on Nov. 7, 2009.

(51) Int. Cl. A47J 31/44

(52) U.S. Cl. 99/288

(57) ABSTRACT

A multiple brewing and dispensing decanter being separated, internally, into a pair or more of a plurality of compartments, so that beverage can be dispensed from one compartment, while freshly brewing beverage may be deposited into an adjacent compartment. The compartmentalized decanter incorporates an access inlet through or proximate top wall, to allow deposit of a freshly brewed beverage therein, and each compartment, proximate its bottom wall, has a spigot to provide for dispensing of the contained brewed beverage.

### CROSS REFERENCE TO RELATED APPLICATION

This non provisional patent application claims priority to the provisional patent application having Ser. No. 61/280,658, having filing date Nov. 7, 2009.

### FIELD OF THE INVENTION

This invention relates to brewing of a beverage, and more specifically relates to a multi compartmentalized decanter for use in combination with the brewer for allowing for simultaneous brewing and dispensing of a brewed beverage, continuously.

### BACKGROUND OF THE INVENTION

Various styles of decanters have long been available in the art. Obviously, in the early days, coffee was brewed into a glass coffee pot, and was kept warm by the brewer base until it was consumed. The problem with that is that while the coffee was maintained in warmth, until it was fully consumed, another pot of fresh coffee could not be brewed until the coffee pot was fully removed. Thus, there is always a gap in the availability of freshly brewed coffee, because of this predicament.

In addition, of recent origin, are the larger decanters that can fit within a oversized brewer, and allow for the brewing of a larger amount of coffee or tea, and have it readily available for dispensing, through usage of the brewing apparatus. But, once again, while the decanter was maintained in a warmth mode, upon the brewer, or if it should be removed, under the later circumstance, the brewed beverage would not maintain heated, because of its removal from the brewer's heating pad. Thus, there is always the predicament that either all of the coffee or tea had to be dispensed, or it had to be removed from the brewer, to brew a fresh pot of beverage, but under those circumstances, maintaining its warmth was nonexistent.

### SUMMARY OF THE INVENTION

This invention primarily relates to the brewing of beverages simultaneously while previously brewed beverage is dispensed, from the same decanter.

The subject matter of this invention relates primarily to a novel decanter that is formed internally with two or more compartments, and access openings at the top of the decanter for attaining entrance into each separate compartment for allowing the entrance of freshly brewed coffee or tea, or other beverage, into the discrete internal compartments of the formed decanter. In addition, proximate the bottom of the decanter, and in proximity with and in open communication with a discrete compartment within the decanter, is a spigot or nozzle, which when opened, allows for deposit of the contained brewed beverage directly into a cup, or the like, in preparation for consumption. In other words, the invention comprises an insulated container, that has inlet openings at the top, such as one access opening for each compartment integrally formed within the decanter, so that a beverage may be freshly brewed by the brewer and deposited directly into the discrete compartment of the decanter, while simultaneously, a consumer may dispense from a spigot opening into a separate compartment contained adjacent the opposite side of the decanter, so that a beverage may be dispensed therefrom, even though the brewing of a fresh beverage is simultaneously taking place, through usage of the novel decanter of this invention.

The decanter may be formed so that it may seat directly upon a hot plate integral of the base of the brewer, or even perhaps the decanter may have its own heating element located within its walls, or base, that can maintain the warmth of a previously brewed beverage, as it is periodically to be dispensed by the consumer.

It is, therefore, the principal object of this invention to provide a multi compartmentalized decanter each of which may accept and hold a plurality of brewed beverages, awaiting its dispensing to any consumer.

Another object of this invention is to provide an integrated decanter, which is internally compartmentalized, so that a pair or more of separate compartments may accept a freshly brewed beverage, for subsequent dispensing, simply through a orientation of the decanter in its placement upon the brewer.

Yet another object of this invention is to provide a continuous supply of freshly brewed beverage, whether it be tea or coffee, or other liquid, all of which may be contained within separate integrated compartments embodied within a singular decanter.

Still another object of this invention is to provide an access opening in the top of a decanter into each discrete integral compartment therein, and with each compartment having its own spigot, proximate at the bottom, for dispensing of any brewed beverage contained therein.

These and other objects may become more apparent to those skilled in the art upon review of the summary of the invention as provided herein, and upon undertaking a study of the description of its preferred embodiment, in view of the drawings.

### DESCRIPTION OF THE DRAWINGS

In referring to the drawings:

FIG. 1 is an isometric view of the multiple brewing and dispensing decanter for the current shown seating under the brew basket of the disclosed brewing apparatus;

FIG. 2 provides an isometric view of a double compartmentalized decanter of this invention, wherein an integrated divider is provided internally of the decanter to separate it into two separate and isolated compartments, each having its own entrance opening, and associated spigot;

FIG. 3a shows a side view of the decanter of FIG. 2;

FIG. 3b shows a front view of the decanter of FIG. 2;

FIG. 3c shows a back view of the decanter of FIG. 2;

FIG. 3d provides a top plan view of the decanter of FIG. 2;

FIG. 4a provides a side view of the decanter of FIG. 2 resting upon the brewer as disclosed in FIG. 1;

FIG. 4b shows a front view of the decanter upon its brewer as disclosed in FIG. 1;

FIG. 5 provides an isometric view of a multi compartmentalized, or four compartment decanter capable of accepting brewed beverage through any one of its access openings at the top, with each compartment capable of dispensing its contained beverage through manipulation of its associated spigot, arranged at the bottom of the shown decanter;

FIG. 6a provides a front view of the decanter of FIG. 5;

FIG. 6b shows a right side view of the decanter of FIG. 5;

FIG. 6c shows a left side view of the decanter of FIG. 5; and

FIG. 6d provides a top plan view of the decanter of FIG. 5.

### DESCRIPTION OF THE PREFERRED EMBODIMENT

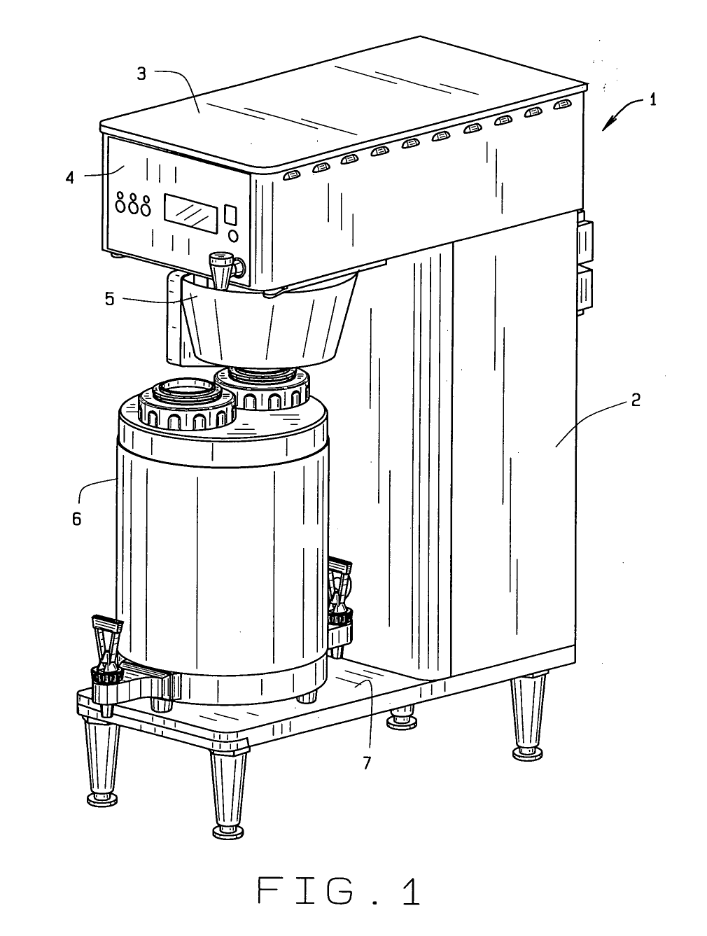

In referring to the drawings, and in particular FIG. 1, a standard brewer 1 is readily disclosed, incorporating its housing 2 and upper compartment 3 having its control panel 4 and supporting a brew basket 5 applied, containing a supply of grounds for brewing through the application of hot water of a fresh beverage into the decanter 6 of this invention. The decanter rest upon the elevated base 7 of the brewer 1, as can be noted.

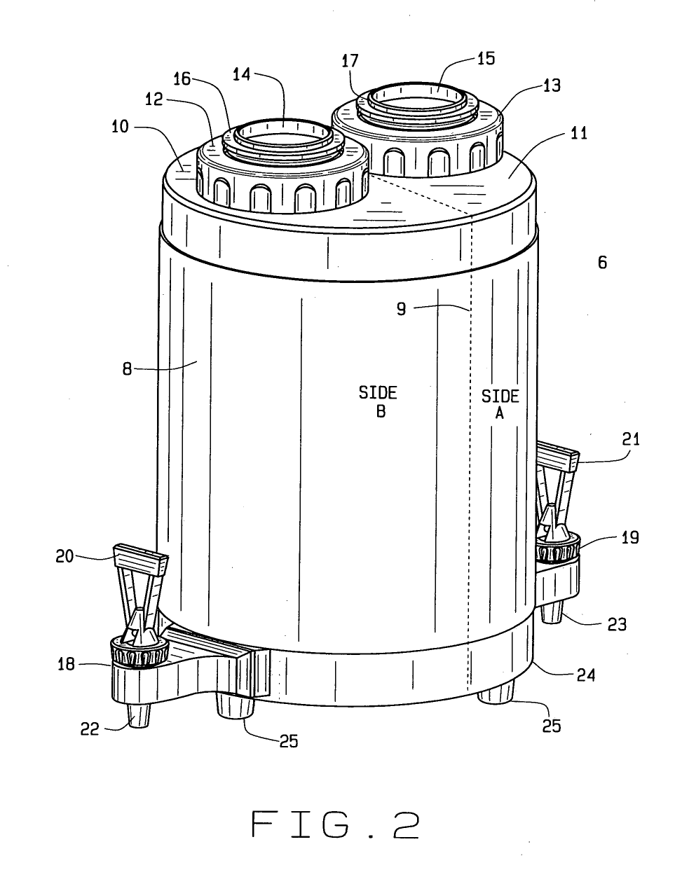

The multiple brewing and dispensing decanter 6 of this invention is readily disclosed in FIG. 2, as can be noted, and it contains an outer wall 8 with an integral divider 9 provided internally within the decanter, so as to separate it into two discrete compartments 10 and 11, as can be noted. Operatively associated with each compartment is an inlet 12 and 13, respectively, and each inlet provide for deposit within its respective compartment of the freshly brewed beverage through the various openings 14 and 15 located through the upper portions of each of the said inlets. Each inlet 12 and 13 is capable of otherwise engaging, or is integrally formed therewith, or can be threadily engaged onto the top of their respected decanter openings (not shown) provided through the upper surface of the compartments 10 and 11, and can be secured into position by known methods. In addition, it can be seen that their may be threads or connecting means 16 and 17 provided with their access openings, so that other closure means may be applied there on, to seal off their heated contents, in the event that the decanter or carafe is moved to a different location. There may be a handle (not shown) operatively associated with the top of the decanter 6, to facilitate its conveyance.

In addition, although it is not shown, it is possible that the sidewalls of the decanter 6, within its housing 8, may be insulated, probably through a double walled structural configuration, in order to sustain the warmth of the various brewed beverages contained within their respective compartments 10 and 11. Furthermore, the decanter may have its own electric element provided therein, within its sidewalls, and which may be electrically charged or battery operative to furnish heat to maintain the warmth of the brewed beverages separately contained therein, during its usage and consumption.

As can be noted proximate the base of the decanter 6 is a spigot for each compartment, with the spigot 18 being operatively associated with the compartment 10, and the spigot 19 being operatively associated with the compartment 11, so that when their operating handles 20 and 21 are manipulated, the separate beverages may be dispensed from their spouts 22 and 23, as can be noted. In addition, the base 24 of the decanter my rest upon legs, as at 25, so as to provide some elevation. Or, it may be that the decanter can be formed without legs, and can rest directly upon the heat pad provided normally within the usually formed brewer 1, in order to help maintain the warmth of any beverages that have been discharged into its separate compartments of the vessel, during brewing.

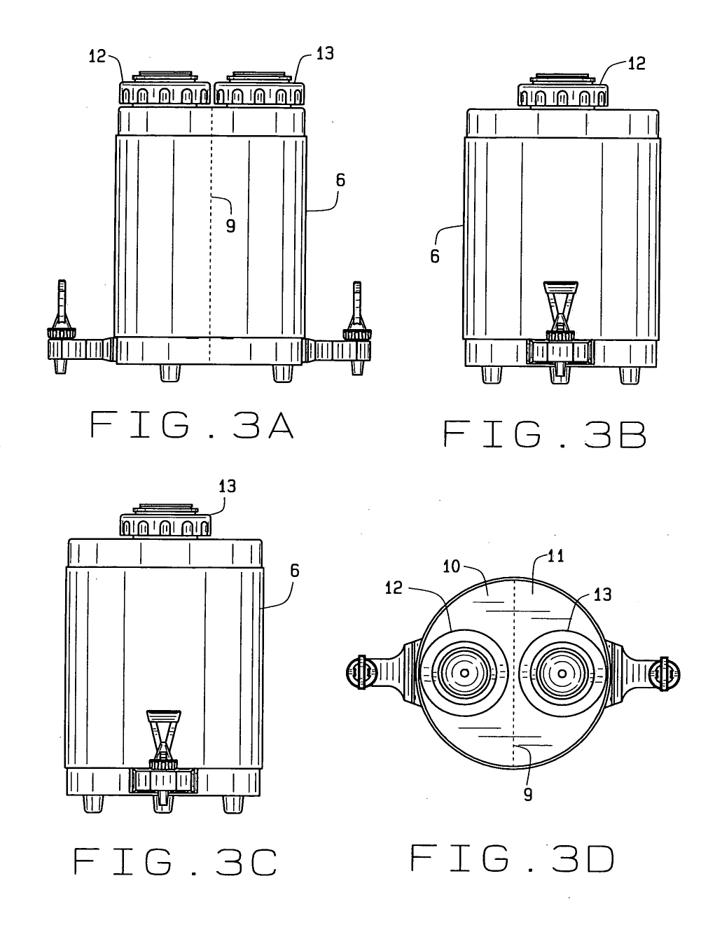

FIG. 3a shows a side view of the decanter 6, showing how the brew inlets 12 and 13 are provided at the front and back of the formed decanter, their respective compartments being separated by the integral partition or divider 9, as can be noted. FIG. 3b shows a front view of the decanter 6, while FIG. 3c provides a back view of the said decanter.

FIG. 3d provides a top view, and it can be readily seen how the access openings or inlets 12 and 13 are arranged to bifurcate the decanter into the two separate compartments 10 and 11 through their internal divider wall 9 as noted.

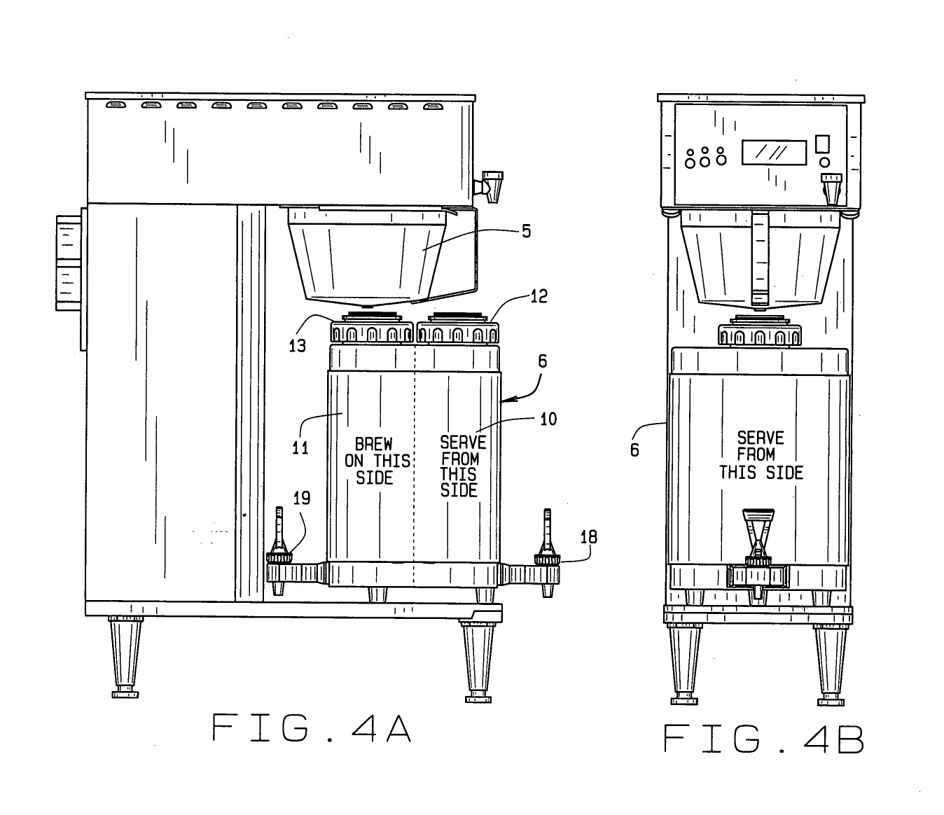

As can be noted in FIG. 4a, the operational usefulness of the structured decanter 6 of this invention can be noted. While the front side compartment 10 is provided for serving its contained beverage, that will already have been previously brewed and deposited from the brew basket 5 through its access opening 12 therein, simultaneously, the brew basket will have been recharged with fresh beverage grounds, and is capable of simultaneous brewing into its separate compartment 11 a fresh batch of hot beverage, the brew basket depositing the brewing beverage through the access opening 13, as can be understood. The spigot 18 can be manipulated for dispensing of the previously brewed beverage from the compartment 10 of the decanter, while the spigot 19 remains closed. A front view of the assembly is also readily disclosed in FIG. 4b.

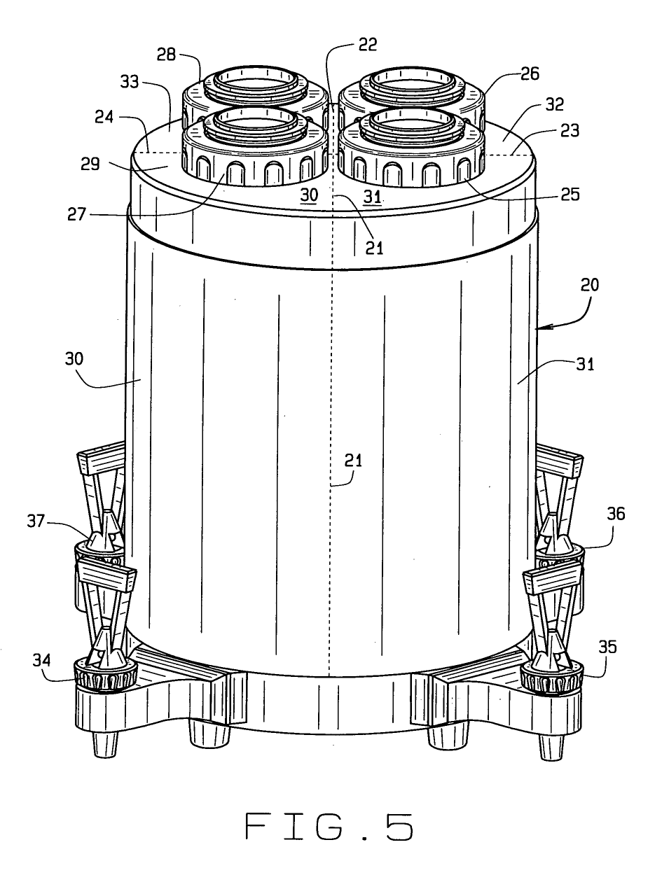

A variation upon the concept of this invention, in providing a multiple brewing and dispensing decanter, can be seen in FIG. 5. The decanter 20 as shown herein is structured in applying the same principle of the segregated decanter as noted at 6, but in this instance, the decanter 20 contains integrally internally four discrete compartments. These compartments are separated by the fluid type dividers 21 through 24, and each compartment has its own access inlet 25 through 28, as can be readily seen. Each of these access inlets are constructed similarly to the inlets 12 and 13 as previously analyzed, and their interconnection with the top wall 29 of the decanter 20 is similar to the structural relationship as previously reviewed. In addition, each of the compartments, as can be seen at 30 through 33 has their own separate spigot 34 through 37 operatively associated therewith, in order to allow for the discrete dispensing of any brewed beverage from the individual compartments through their respective spigot when a consumer wishes to pour a cup of coffee, tea, hot chocolate, or the like, from the various compartments of the shown decanter 20.

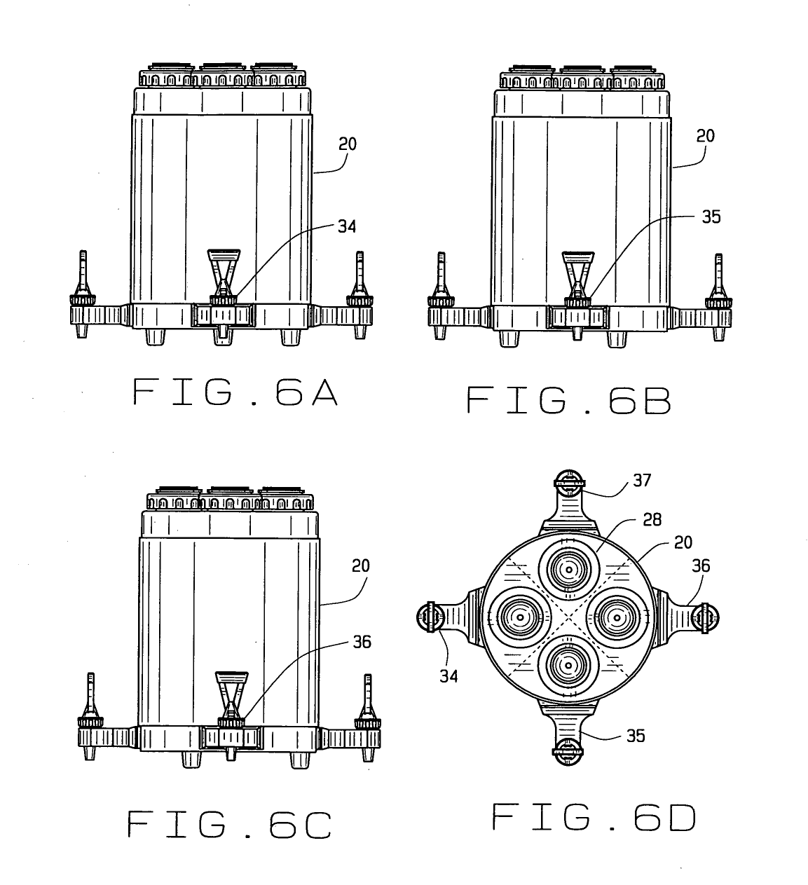

FIG. 6a provides a front view of the decanter 20 showing the relationship of the various spigots mounted at quarter segments of the compartmentalized dispenser, while FIG. 6b provides a right side view, and FIG. 6c provides a left side view of the decanter. Thus, FIG. 6d provides the top view of the structured decanter 20, and indicates how, in this instance, freshly brewed beverage may be dispensed from the spigot 35, while simultaneous a freshly brewed beverage exiting the brew basket 5 may be deposited within the access opening 28, to fill up that compartment of the decanter with a freshly brewed beverage. Hence, the concept of attaining simultaneousness in the dispensing of the beverage, while brewing a fresh beverage, can be readily determined from reviewing these drawings.

Variations or modifications to the structure of this decanter may readily occur to those skilled in the art upon reviewing the summary of the invention as provided herein, and for analyzing the description of the preferred embodiment, in view of the drawings. Any variations, within the spirit of this development, are intended to be encompassed within the scope of the invention disclosed and analyzed herein. The description of the preferred embodiment, and their depictions in the drawings, are set forth for illustrative purposes only.

1. A multiple brewing and dispensing decanter, said decanter having a housing, said housing having a top surface, and a bottom, said decanter having at least one partition integrally formed within its interior to separate the interior of the housing into at least two compartments, each compartment having an access opening provided through the top wall of the housing to provide entrance of a brewing beverage into the separate compartments of the housing during a brewing cycle, and each compartment having a spigot operatively associated approximate the bottom of the housing, to simultaneously allow for discrete dispensing of the brewed beverage contained in its associated compartment.

2. The dispensing decanter of claim 1 wherein there are two compartments formed within the interior of the decanter housing.

3. The dispensing decanter of claim 1 wherein there are three compartments disposed within the decanter housing.

4. The dispensing decanter of claim 1 wherein there are four compartments contained within in the decanter housing.

5. The dispensing decanter of claim 1 wherein the decanter housing is insulated.

6. The dispensing decanter of claim 1 and including a heating element provided interiorly of the housing of the decanter to maintain the warmth of the contain beverages.

7. The dispensing decanter of claim 1 wherein the access inlets into the separate compartments of the housing are removable fastened to the top wall of the housing.

8. The brewing decanter of claim 7 wherein closure means provided for fastening onto the access opening to furnish closure to each inlet of the compartments.

9. The dispensing decanter of claim 7 wherein the access inlets are threadidly engaged onto the top wall of the housing.
